(19) United States
(12) Patent Application Publication
(10) Pub. No.: US 2002/0182111 A1
(43) Pub. Date: Dec. 5, 2002

(54) Method and apparatus for visible spectrum imaging

(76) Inventor: Ilya Feygin, Mountainside, NJ (US)

Correspondence Address: DEMONT & BREYER, LLC, PO BOX 7490, SHREWSBURY, NJ, 07702, US

(21) Appl. No.: 09/872,207

(22) Filed: Jun. 2, 2001

(51) Int. Cl. G01N 21/25

(52) U.S. Cl. 422/82.05

(57) ABSTRACT

An imager for imaging visible-spectrum electromagnetic radiation that is emitted from reagents due to the occurrence of cellular, physiological or molecular events. The imager includes a detector for detecting the emitted visible-spectrum electromagnetic radiation. The detector is situated in the immediate proximity of a specimen plate that receives the reagents. In some embodiments, the gap between the reagents and the detector is less than about 7 millimeters. In some embodiments, there are no optics present in between the reagents and the detector that would otherwise focus the emitted light on the detector.

### FIELD OF THE INVENTION

The present invention relates to an apparatus for imaging visible spectrum electromagnetic radiation that is emitted during cellular, physiological and molecular events.

### BACKGROUND OF THE INVENTION

In assay screening, a large number of cellular events (e.g., calcium flux, etc.), physiological events and/or molecular events (e.g., chemical reactions, etc.) are monitored and analyzed. These events, hereinafter referred to as “target events,” are usually carried out in parallel in an array of deposits on specimen plates. The specimen plates are typically glass or plastic slides, or multi-well (e.g., micro-titer) plates.

Due to the large number of events taking place on the plates, time-consuming methods that directly examine each deposit (e.g., microscopic examination, etc.) are unsuitable for data acquisition. Rather, a “snap shot” of the whole plate is advantageously taken via imaging systems. Two important visible-spectrum imaging techniques include fluorescence imaging and luminescence imaging.

In fluorescence imaging, when a target event occurs, a detection reagent emits light (i.e., fluoresces) when excited by an appropriate excitation source, such as ultraviolet light, etc. The detection reagent is chosen for its ability to interact (e.g., bind, etc.) with a compound or to respond to a specific stimulus that is present only if the target event occurs. The emitted light, which provides qualitative and/or quantitative information about the event, is captured and converted to electrical signals using, for example, a charge coupled device (“CCD”). The CCD comprises an array of thousands of sensor cells that are capable of receiving radiation from multiple wells at the same time. The signals are analyzed, via suitable processing electronics/software, to recover information concerning the target event.

FIG. 1 depicts a simplified schematic of a typical imaging 100 device for fluorescence imaging. Imager 100 includes cooled CCD camera 102, emission filter 104, optics 106, filter wheel 108 and illumination source 110, interrelated as shown. Other elements that are part of, or otherwise associated with imager 100 but are not shown in FIG. 1 include a camera control unit, a computer with analysis software, a specimen positioner and a liquid dispenser.

In operation, excitation radiation 112 from illumination source 110 is delivered to specimen 114, which can be, for example, a multi-well plate containing a plurality of compounds. Excitation radiation 112 is delivered, for a pre-determined period of time, toward a selected well, group of wells or the entire multi-well plate. At the end of the time period, the delivery of excitation radiation 112 ceases and a response (i.e., fluorescence) is detected. As appropriate, a next well or group of wells receives excitation radiation 112 for the appropriate length of time, and, after radiation ceases, a response is detected, and so forth. In a process called time resolved fluorescence (“TRF”), after excitation radiation 112 ceases, the response is monitored after a specific delay of a few milliseconds. Since illumination source 110, which is typically an arc lamp, cannot be switched on and off rapidly enough for either standard fluorescence imaging or TRF, filter wheel 108 “chops” the excitation radiation, producing a rapid on-off response.

Optics 106, which typically includes several lenses, deliver excitation radiation 112 to specimen 114. Stray light that is reflected back through optics 106 is removed by emission filter 104. Optics 106 are also used to collect light 116-1, 116-2 emitted from assays that are within specimen 114. Emitted light 116-1, 116-2 passes through emission filter 104 and is received by CCD camera 102.

As shown in FIG. 1, the emitted light traverses the medium (e.g., air, etc.) between specimen 114 and optics 106, passes through optics 106, traverses the medium between optics 106 and emission filter 104, passes through the emission filter 104 and traverses the medium between emission filter 104 and camera 102. Passing light through these mediums and through optics 106 and filter 104 attenuates emitted light 116-1, 116-2. As a consequence, the sensitivity and resolution of the camera are compromised. To reduce the severity of this problem, optics 106 must be of very high quality and are typically quite expensive. Also, unless optics 106 includes a telecentric lens that collects parallel rays of light over the entire surface of specimen 114, parallax related aberrations result.

Consequently, full plate (field) fluorescent imaging devices are usually very complex and often quite expensive, costing as much as several hundred thousand dollars. See, for example, the fluorescence imagers (FLIPR systems) available from Molecular Devices Corporation (www.moldev.com).

Luminescent imaging (chemi- or bio-) is similar to fluorescence imaging, except that excitation radiation is not required. But many of the luminescent reactions have such low intensity emission that a highly optimized imaging system, including the most sensitive form of cooled CCD camera and very efficient lenses, are required.

The art would therefore benefit from visible spectrum imaging systems that avoid at least some of the complexity, expense and other drawbacks of prior art visible-spectrum imaging systems.

### SUMMARY OF THE INVENTION

The present invention pertains to a visible-spectrum imaging apparatus and a method for imaging by which target events are monitored. Some imagers in accordance with the illustrative embodiment of the present invention comprise a detector, such as a CCD array, that is separated by a small space from a specimen plate, such as a multi-well plate. A filter for rejecting excitation radiation, which is typically blue or ultra violet, but that passes visible spectrum light, is sandwiched between the multi-well plate and the detector so that only emitted light reaches the detector.

Unlike a typical prior art imager, in an imager in accordance with the illustrative embodiment of the present invention, the reagents, etc., involved in the target events are in the immediate proximity of the detector such that there is only a small gap therebetween. In some variations, the gap between the reagents, etc., and the detector is less than 6-7 millimeters. Consequently, the sensitivity and resolution of imagers in accordance with the illustrative embodiment of the present invention are increased relative to that of prior art imagers. In addition, in some embodiments, imagers described herein do not include optics for collimating and focusing emitted radiation, thereby reducing cost and complexity compared to the prior art.

### BRIEF DESCRIPTION OF THE DRAWINGS

FIG. 1 depicts a simplified schematic of a typical prior art fluorescence imaging system.

FIG. 2 depicts an imaging system in accordance with the illustrative embodiment of the present invention.

FIG. 3 depicts further details of the imaging system depicted in FIG. 2.

FIG. 4 depicts a variation of the imaging system depicted in FIG. 2.

FIG. 5 depicts a further variation of the imaging system depicted in FIG. 2.

FIGS. 6A-6F depict the minimum gap between the detector and liquid reagents for variations on the arrangement of the detector, filter and specimen plate shown in FIG. 3.

FIGS. 7A-7C depict the minimum gap between the detector and liquid reagents for variations on the arrangement of the detector and specimen plate shown in FIG. 5.

FIG. 8 depicts light that is emitted from wells diverging as it propagates away from such wells.

FIG. 9 depicts a plot of the intensity of light received by a detector as a function of detection region for varying distances between the source of the emitted light and the detector.

FIG. 10 depicts, via an exploded view, an arrangement for determining the maximum acceptable size of the gap between the source of emitted light and the detector.

FIG. 11 depicts the arrangement of FIG. 10 in use.

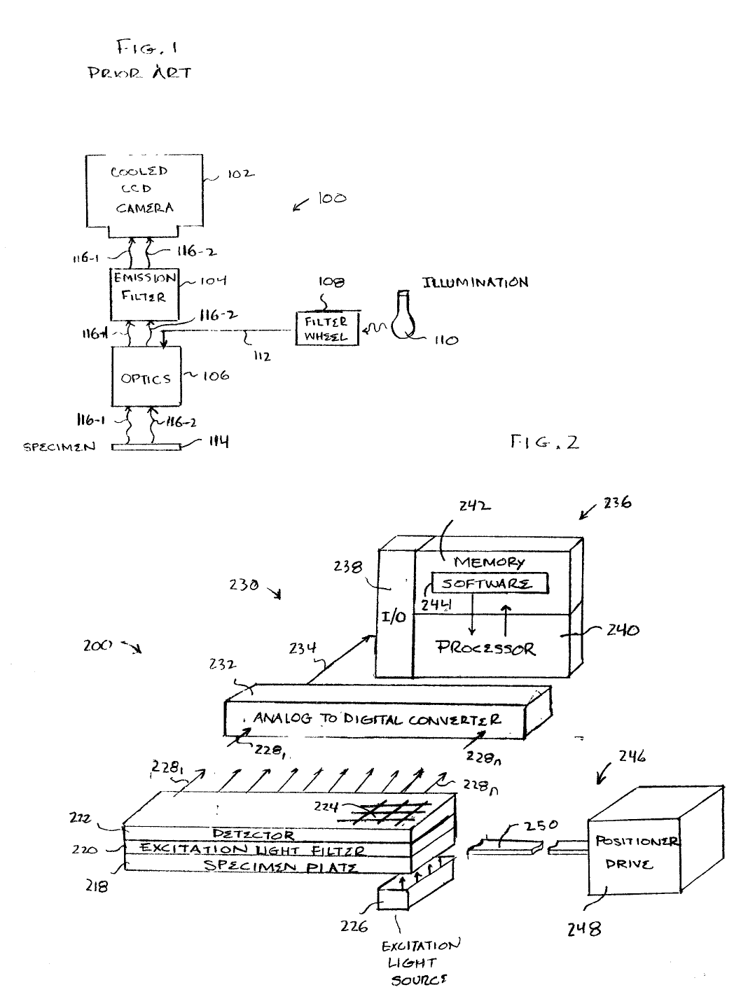

### DETAILED DESCRIPTION

The terms listed below are given the following specific definitions for the purposes of this specification.

“Reagents” means cellular material, non-cellular material and/or chemicals. Generally, the term “reagent” means anything that is a reactant, solvent or otherwise participates in target events.

“Specimen plate” means a plate on which reagent(s) are disposed. The term “specimen plate” includes multi-well (e.g., micro-titer) plates. Such plates have a plurality of wells (96-well, 384-well, 1536-wells are typical) that are organized in a two dimensional array. The term “specimen plate” also refers to a glass or plastic slide that does not have wells, upon which reagents are deposited in large two-dimensional arrays.

“Target Events” means cellular, physiological and/or molecular events, such as, for example, calcium flux, chemical reactions, etc.

“Visible Spectrum Radiation” means radiation having a wavelength in the visible range, which is in a range of about 390 nanometers to about 780 nanometers.

Other terms that are to be given a specific definition for the purposes of this specification are identified later herein in bold font and set-off by quotation marks.

Imaging systems in accordance with the illustrative embodiment of the present invention are capable of imaging visible-spectrum light that is emitted either as a direct consequence (luminescence) or indirect consequence (fluorescence) of the occurrence of target events. Fluorescent and luminescent imaging are well known to those skilled in the art and therefore will not be described at length herein. With regard to the following description, it is understood that for fluorescent imaging, an excitation radiation source and some means for preventing excitation radiation from reaching the detector are required. Furthermore, fluorescent imaging requires assays that include a detection reagent that fluoresces on exposure to light having an appropriate wavelength. Luminescent imaging, on the other hand, requires neither a detection reagent nor an excitation radiation source.

In contrast to the prior art, some imaging systems in accordance with the illustrative embodiment of the present invention have a very small gap between the detector and the reagents on the specimen plate. Furthermore, unlike the prior art, some imaging systems in accordance with the illustrative embodiment of the present invention do not use optics (e.g., lenses, etc.) between the specimen plate and the detector to collimate or focus emitted light.

For some imaging systems described in this specification, the gap between the reagents and the detector plate is less than about seven millimeters, and even as small as about one millimeter. The size of this gap is a function of several parameters, including the resolution capability of the sensor as well as the geometry of the wells (for multi-well plates) and the specific arrangement of the specimen plate, excitation radiation filter and detector. Consequently, for some imaging systems described herein, the gap might be larger than seven millimeters, as a function of those parameters. A methodology for determining gap size is described later in this specification after several variants of an imaging system in accordance with the illustrative embodiment of the present invention are described.

FIG. 2 depicts imaging system 200 in accordance with the illustrative embodiment of the present invention. Imaging system 200 comprises specimen plate 218, excitation radiation filter 220, detector 222, excitation radiation source 226, signal processing electronics 230 and positioner 246, arranged as shown. When configured for luminescent imaging, imaging system 200 does not require excitation radiation source 226 and excitation radiation filter 220.

In imaging system 200 depicted in FIG. 2, excitation radiation source 226 is disposed beneath specimen plate 218, which is in turn disposed beneath excitation radiation filter 220, which is in turn disposed beneath detector 222. Many variations on this specific arrangement (i.e., detector 222 above filter 220 above specimen plate 218) are suitable for use in conjunction with the illustrative embodiment of the present invention. Several of these variations are described later in this specification.

In use, specimen plate 218 has a plurality of reagents disposed thereon. Specimen plate can be either a multi-well plate, well known in the art, or simply a slide or flat planar piece of material (e.g., quartz, glass, etc.). When specimen plate 218 is a multi-well plate, reagents are contained within the wells thereof. When specimen plate 218 is implemented as a slide, reagents are advantageously disposed thereon as an array of individual deposits. In the description that follows, the term “well” is meant to include a deposit on a slide unless it is clear from the context that the description pertains only to a well.

Detector 222 detects visible-spectrum light that is generated either directly (i.e., via luminescence) or indirectly (i.e., via fluorescence) from target events that are occurring on specimen plate 218. In some embodiments, detector 222 is a CCD camera, well known in the art, that comprises a number of sensor cells 224.

When exposed to electromagnetic radiation having a wavelength that is within its operating range, detector 222 generates electrical signals 228_{i, i=1,n}. Signals 228_{i, i=1,n} are then delivered to signal processing electronics 230 for analysis. Signal processing electronics 230 include analog-to-digital (“A/D”) converter 232 and data processing system 236. AID converter 232 converts analog signals 228_{i, i=1,n} to digital signals 234 suitable for processing by data processing system 236.

Data processing system 236 comprises input/output (“I/O”) 238, processor 240, and data storage device 242. I/0 238 includes machine interfaces (e.g., input and output ports, etc.) and human interfaces (e.g., keyboard, monitor, etc.). Data storage device 242 is advantageously a non-volatile memory. Processor 240 is capable of storing data in and retrieving data from data storage device 242, and is further capable of executing programs, such as analysis software 244, that are stored in data storage device 242, and of outputting data to I/O 238. Data processing should be fast enough and powerful enough to simultaneously monitor all wells. This is especially important for time resolved fluorescence (“TRF”) imaging, as is known in the art.

In some variations, imaging system 200 includes positioner 246, which incorporates positioner drive 248 and drive linkage 250. Positioner 246 is used to move specimen plate 218 between a second position, wherein it is underneath detector 222 as depicted in FIG. 2, to a first position, wherein specimen plate 218 is not beneath detector 222. This allows specimen plate 218 to be emptied and refilled. In a variation of imaging system 200 depicted in FIG. 2, positioner 246 can suitably engage detector 222 for movement, rather than moving specimen plate 218. Positioner 246 can be any one of a variety of mechanisms known in the art, such as, without limitation, a motorized linear positioning stage.

As previously discussed, fluorescent imaging requires excitation light. Consequently, for fluorescent imaging, imaging system 200 must be configured to:

allow excitation radiation to reach specimen plate 218; and

prevent excitation radiation from saturating or swamping detector 222.

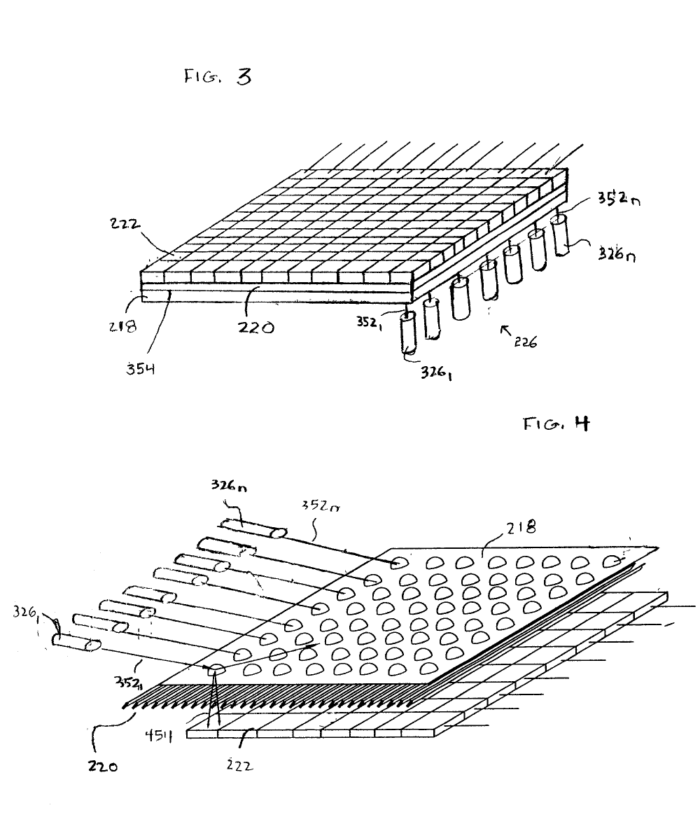

These requirements can be satisfied by several variations of the specific arrangement of excitation radiation source 226, specimen plate 218, excitation radiation filter 220, and detector 222 depicted in FIG. 2. The specific arrangement depicted in FIG. 2 is now described in more detail with reference to FIG. 3, and several variations of that specific arrangement are described thereafter.

With reference to FIG. 3, excitation radiation source 226 is disposed beneath specimen plate 218, which is in turn disposed beneath excitation radiation filter 220, which is in turn disposed beneath detector 222. Excitation radiation source 226 comprises a plurality of individual light sources 326_{i=1,n}, that can be, without limitation, light emitting diodes or lasers operating at a wavelength that is suitably selected to excite fluorescence from the detection reagent being used. Excitation radiation 352_{i=1,n} from the excitation radiation sources causes any fluorescent detection reagents that have interacted with a target (indicative of cellular activity, a chemical reaction, etc., at that site) to fluoresce. The wavelength of excitation radiation typically falls in a range from ultraviolet light (c.a. 340 nanometers) to blue light (c.a. 488 nanometers).

In the specific arrangement depicted in FIG. 3, there are fewer excitation radiation sources 326_{i=1,n} than wells on specimen plate 218. Consequently, excitation radiation sources 326_{i=1,n} are rapidly scanned across specimen plate 218 by a scanning mechanism (not shown), so that all regions of the specimen plate are illuminated with excitation radiation 352_{i=1,n}. Alternatively, specimen plate 218 can be moved past excitation radiation sources 326_{i=1,n}. In yet a further variation, a full array of excitation radiation sources 326_{i=1,n} equal in number to the wells in specimen plate 218 is provided, such that scanning is not required. In any case, small light sources having a selected spectral emission (e.g., ultra violet, blue, etc.), such as LEDs, are advantageously used as excitation radiation sources 326_{i=1,n}. Small light sources can be rapidly turned on and off such that the filter wheel used in some prior art imaging systems is avoided.

For the arrangement depicted in FIG. 3, excitation radiation filter 220 comprises a material that is opaque to excitation radiation but transparent to visible light. As a consequence, excitation radiation filter 220 substantially prevents excitation radiation 352_{i=1,n} from reaching detector 222, yet passes the visible light emitted by fluorescing reagents. Materials suitable for forming excitation radiation filter 220 include, without limitation, gels, and thin film deposits on glass, quartz and other substrates, as are known to those skilled in the art.

When a multi-well plate is used for specimen plate 218, upper surface 354 of specimen plate 218 can abut excitation radiation filter 220, since the level of the reagents can be kept below the mouth of each well. As specimen plate 218 is moved out from underneath excitation radiation filter 220 (e.g., for refilling, etc.) by positioner 246 (see FIG. 2), the surface of excitation radiation filter 220 is advantageously wiped or otherwise cleaned in known fashion (e.g., robotically, etc.).

Due to the small diameter of the wells in 1536-well plates, such plates can be inverted (i.e., the mouth of the wells face downward) without losing liquid from the wells. When the multi-well plate (i.e., specimen plate 218) is inverted, the bottom thereof can abut excitation radiation filter 220. This enables arrangements wherein radiation filter 220 is disposed beneath specimen plate 218.

When a slide or flat-surfaced piece of material is used for specimen plate 218, reagents are deposited in an array on upper surface 354 thereof. Consequently, the slide is advantageously spaced from excitation radiation filter 220 by a small gap to prevent contamination of the filter.

In a further variation, the arrangement depicted in FIG. 3 can be “flipped” such that excitation radiation sources 326_{i=1,n} are disposed above specimen plate 218, which is in turn disposed above excitation radiation filter 220, which is in turn above detector 222. In this flipped variation (not depicted), the lower surface of specimen plate 218 can abut excitation radiation filter 220 without risk of contamination (since the reagents reside on the upper surface of specimen plate 218, or near to it in wells).

For the arrangement depicted in FIG. 3, and the “flipped” version thereof, the distance between the reagents on specimen plate 218 and detector 222 is quite small, typically little more than the thickness of excitation radiation filter 220 (c.a., less than about 1 millimeter).

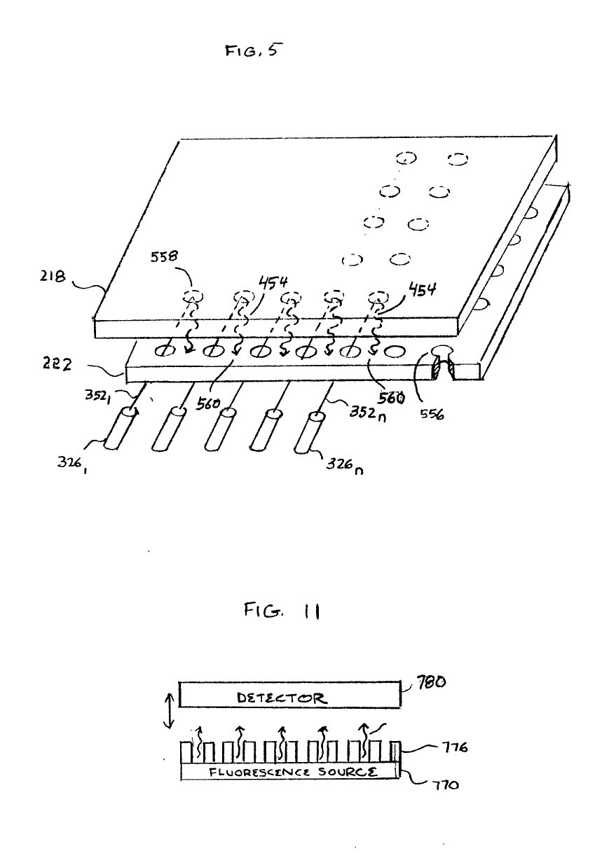

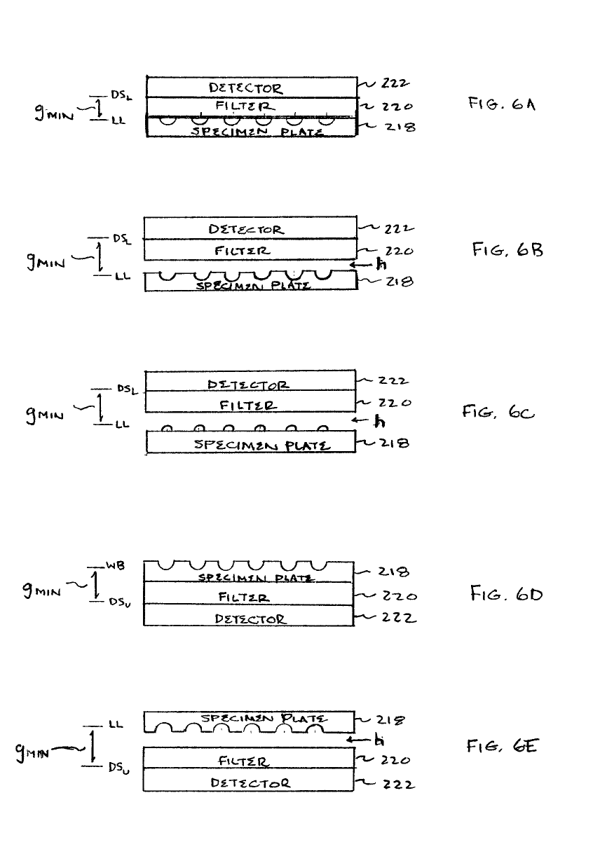

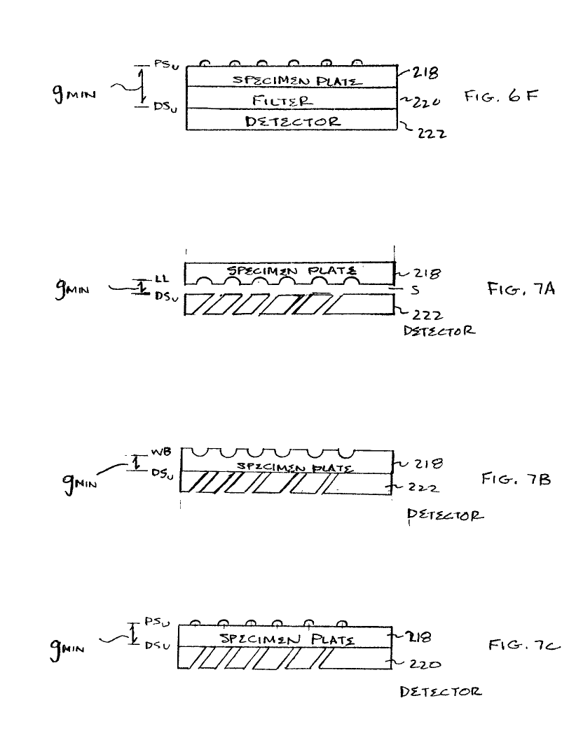

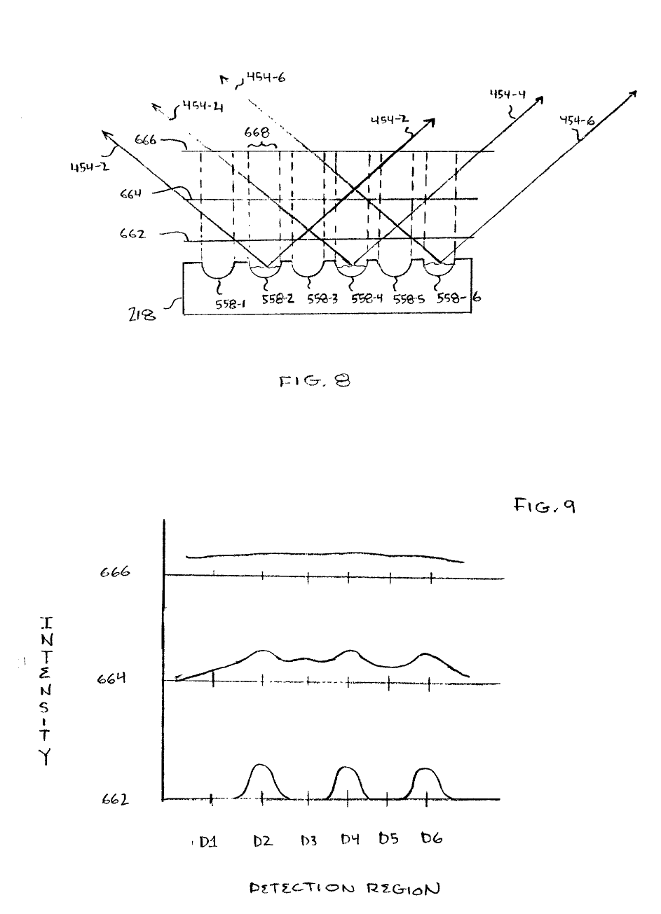

In a variation depicted in FIG. 4, excitation radiation sources 326_{i=1,n} are disposed above and to the side of specimen plate 218, which is in turn disposed above excitation radiation filter 220, which is in turn disposed above detector 222. In this variation, excitation radiation filter 220 is a grating filter.

As previously described, when there are fewer excitation radiation sources 326_{i=1,n} than wells, either the excitation radiation sources or specimen plate 218 is scanned so that all regions of the plate are illuminated with excitation light. Alternatively, a full array of excitation radiation sources 326_{i=1,n} equal in number to the wells in specimen plate 218, is used to avoid the need for scanning.

Excitation radiation sources 326_{i=1,n} are positioned relative to specimen plate 218 such that excitation radiation 352_{i=1,n} strikes specimen plate 218 at a shallow angle. In particular, the angle of incidence of the excitation radiation relative to the surface of specimen plate 218 is advantageously less than about 30 degrees. As a consequence, much of incoming excitation radiation 352_{i=1,n} is reflected by specimen plate 218 and does not pass to excitation radiation filter 220.

To the extent that some of excitation radiation 352_{i=1,n} is not reflected by specimen plate 218, it is diffracted by excitation radiation filter 220 so that it does not reach detector 222. Yet, visible light (i.e., fluorescence) 454 emitted from the assays, which is directed substantially perpendicular to excitation radiation filter 220, passes through the filter and reaches detector 222.

In this embodiment, the gap between detector 222 and the reagents on specimen plate 218 is again quite small, amounting to the thickness of grating filter 220 and at least a portion of the thickness of the specimen plate.

FIG. 5 depicts yet a further variation of imaging system 200 in accordance with the illustrative embodiment of the present invention. In the variation depicted in FIG. 5, excitation radiation sources 326_{i=1,n} are disposed beneath detector 222, which is in turn disposed beneath specimen plate 218.

In this variation, detector 222 serves as both a detector and an excitation radiation filter. A polymer photodiode array is advantageously used as detector 222. A polymer blend containing regio-regular poly(3-alkyl thiophene), hereinafter “P3AT,” and [6,6]-PCBM is suitable for imaging applications in the visible spectrum. PCBM is a derivative of buckminsterfullerene (C60). The blend is spin cast at room temperature to form a film suitable for use as a photodetector. See, Yu et al., “Large Area, Full-Color, Digital Image Sensors Made With Semiconducting Polymers,” Synthetic Metals 111-112, pp. 133-137 (2000), incorporated by reference herein.

Holes 556 are formed in the polymer photodiode array using, for example, a laser or other conventional hole-forming means. In operation, excitation radiation 352_{i=1,n} is passed through holes 556 to reach wells 558 in specimen plate 218. Excitation radiation 352_{i=1,n} stimulates fluorescence 454, which is received by detector 222 at detection regions 560 between holes 556. Wells 558 are advantageously centered over detection regions 560 so that fluorescence 454 is directed thereto. Holes 556 in detector 222 are therefore offset from wells 558. To the extent that excitation radiation 352_{i=1,n} is reflected out of wells 558, due to the offset, the light follows a path toward the adjacent hole 556, rather than toward detection regions 560.

Wells 558 are advantageously physically adapted for anti-reflection to decrease any tendency for excitation radiation 352_{i=1,n} to be reflected to detection regions 560. An anti-reflection characteristic can be provided, for example, by roughening the surface of wells 558. Alternatively, wells 558 can be coated with a noble (i.e., non-reactive), non-reflective material in known fashion.

As previously described, in imaging systems in accordance with the illustrative embodiment of the present invention, the reagents under observation are in the immediate proximity of the detector 222. A definition of the term “immediate proximity” for use in this specification follows.

The term “immediate proximity” is defined by describing or defining a lower bound and an upper bound thereof. The lower bound of the term “immediate proximity” is gₘᵢₙ, which is the minimum allowable size of the gap g between reagents on specimen plate 218 and detector 222. Refer to FIGS. 6A-6F and 7A-7C.

FIGS. 6A-6F depict, via a simplified cross-section, the physical relationship of detector 222, excitation radiation filter 220 and specimen plate 218 to one another for several variants of the arrangement shown in FIG. 3. FIGS. 6A-6C depict the arrangement, previously described, wherein detector 222 is disposed above specimen plate 218. In FIGS. 6A and 6B, specimen plate 218 is a multi-well plate.

In FIG. 6A, specimen plate 218 abuts excitation radiation filter 220. Minimum gap size gₘᵢₙ is defined as the distance between the lower surface DS_{L} of detector 222 and liquid level LL in wells 558. In this case, gₘᵢₙ equals the sum of the thickness of excitation radiation filter 220 and the distance between the liquid level in wells 558 and the upper surface of specimen plate 218. The thickness of excitation radiation filter 220 can be assumed to be about 1 millimeter. The depth of a well in a 96-well plate is about 9-10 millimeters, and the depth of a well in a 1536 well plate is about 1.5 millimeters. Assuming that a well is at least one-half full with liquid, gₘᵢₙ for the arrangement of FIG. 6A with a 96-well plate is about 6 millimeters or less, and gₘᵢₙ for a 1536-well plate is less than about 2 millimeters.

In FIG. 6B, specimen plate 218 is separated from excitation radiation filter 220 by separation h that allows for a flow of inert gas which aids in keeping the surface of excitation radiation filter 220 clean. Typically, separation h is about one millimeter. Minimum gap size gₘᵢₙ is again defined as the distance between the lower surface DS_{L} of detector 222 and liquid level LL in wells 558. But in this case, gₘᵢₙ equals the sum of the thickness of excitation radiation filter 220, the separation h, and the distance between the liquid level in wells 558 and the upper surface of specimen plate 218. Assuming that a well is at least one-half full with liquid, gₘᵢₙ for the arrangement of FIG. 6B with a 96-well plate is about 7 millimeters or less, and gₘᵢₙ for a 1536-well plate is less than about 3 millimeters.

In FIG. 6C, specimen plate 218 is a slide. Reagents are disposed in an array of droplets on the upper surface of specimen plate 218. The droplets are spaced from excitation radiation filter 220 by separation h that ensures that the droplets do not contact excitation radiation filter 220. Typically, the separation h is about one millimeter. Minimum gap size gₘᵢₙ is defined as the distance between the lower surface DS_{L} of detector 222 and liquid level LL on specimen plate 218. In this case, gₘᵢₙ equals the sum of the thickness of excitation radiation filter 220 and the separation h minus the height of the liquid droplet above specimen plate 218. Assuming that the liquid droplet does not wet specimen plate 218, such that the drop is substantially hemispherical, and that the droplets are dispensed in a 1536 array, the height of the droplet will be about 0.5 mm. Therefore, gₘᵢₙ is about 1.5 millimeters.

FIGS. 6D-6F depict a variation, previously described, wherein specimen plate 218 is disposed above detector 222. In FIGS. 6D and 6E, specimen plate 218 is a multi-well plate.

In FIG. 6D, specimen plate 218 abuts excitation radiation filter 220. Minimum gap size gₘᵢₙ is defined as the distance between bottom WB of wells 558 and upper surface DS_{U} of detector 222. In this case, gₘᵢₙ equals the sum of the thickness of excitation radiation filter 220 and the distance between the bottom of wells 558 and the lower surface of specimen plate 218. A 96-well plate has an overall thickness of about 15 millimeters and a well in a 96-well plate has a depth of about 9-10 millimeters. Therefore, gₘᵢₙ is about 6 millimeters for a 96-well plate.

In FIG. 6E, specimen plate 218 is inverted and is spaced from excitation radiation filter 220. The separation h between the specimen plate and the excitation radiation filter allows for a flow of inert gas which aids in keeping the surface of excitation radiation filter 220 clean. Typically, separation h is about one millimeter. Minimum gap size gₘᵢₙ, is defined as the distance between liquid level LL in wells 558 and upper surface DS_{U} of detector 222. In this case, gₘᵢₙ equals the sum of the thickness of excitation radiation filter 220, separation h, and the distance between the liquid level in wells 558 and the inverted upper surface of specimen plate 218. Assuming that a well is at least one-half fill with liquid, gₘᵢₙ for the arrangement of FIG. 6E with a 1536-well plate is less than about 3 millimeters.

In FIG. 6F, specimen plate 218 is a slide, the lower surface of which abuts excitation radiation filter 220. Reagent is disposed in an array of droplets on the upper surface of specimen plate 218. Minimum gap size gₘᵢₙ is defined as the distance between the upper surface PS_{U} of specimen plate 218 and the upper surface DS_{U} of detector 222. For this case, gₘᵢₙ equals the sum of the thickness of excitation radiation filter 220 (˜1 millimeter) and the thickness of specimen plate 218 (˜1-1.5 millimeters). Therefore, gₘᵢₙ is about 2.5 millimeters or less.

FIGS. 7A-7C depict, via a simplified cross-section, the physical relationship of specimen plate 218 and detector 222 to one another for several variations on the configuration shown in FIG. 5. In FIGS. 7A and 7B, specimen plate 218 is a multi-well plate.

In FIG. 7A, specimen plate 218 is inverted and is spaced by space S from detector 222. Space S between the specimen plate and the detector allows for a flow of inert gas that aids in keeping the surface of detector 222 clean. Typically, the space is about one millimeter. Minimum gap size gₘᵢₙ is defined as the distance between liquid level LL in wells 558 and upper surface DS_{U} of detector 222. In this case, gₘᵢₙ equals the sum of space S, and the distance between the liquid level in wells 558 and the inverted upper surface of specimen plate 218. Assuming that a well is at least one-half full with liquid, gₘᵢₙ for the arrangement of FIG. 7A with a 1536-well plate is less than about 2 millimeters.

In FIG. 7B, specimen plate 218 abuts detector 222. Minimum gap size gₘᵢₙ is defined as the distance between bottom WB of wells 558 and upper surface DS_{U} of detector 222. In this case, gₘᵢₙ equals the distance between the bottom of wells 558 and the lower surface of specimen plate 218, which, for a 96-well plate, is about 5 millimeters.

In FIG. 7C, specimen plate 218 is a slide, the lower surface of which abuts detector 222. Reagents are disposed in an array of droplets on the upper surface of specimen plate 218. Minimum gap size gₘᵢₙ is defined as the distance between the upper surface PSᵤ of specimen plate 218 and the upper surface DS_{U} of detector 222. For this case, gₘᵢₙ equals the thickness of specimen plate 218 or about 1 millimeter.

In view of the foregoing description, it will be understood that the lower bound of the term “immediate proximity” is a function of the specific physical relationship between the various elements used for detection, filtering and for supporting the reagents. It should also be clear that, regardless of the specific variation on imaging system 200, the lower bound gₘᵢₙ is quite small, typically in the range of about 1-7 millimeters. The space S between specimen plate 218 and detector 222 is typically about 2 millimeters or less. Furthermore, separation h, if any, between specimen plate 218 and excitation radiation filter 220 is typically about 1 millimeter or less.

The upper bound gₘₐₓ of the term “immediate proximity” is the maximum allowable size of the gap g between the reagents and detector 222. Refer to FIGS. 8-11.

As gap g widens, the light emitted from each well diverges. This phenomenon is depicted in FIG. 8. FIG. 8 depicts specimen plate 218 having a plurality of wells 558-1 through 558-6. Well 558-2 emits light 454-2, well 558-4 emits light 454-4 and well 558-6 emits light 454-6. There is no emission of light from wells 558-1, 558-3 and 558-5. Planes 662, 664 and 666 intersect the emitted light at a successively increasing distance from the wells. For pedagogical purposes, these planes are assumed to represent the surface of detector 222 at such successively increased distance from the wells.

The dashed lines rising from the perimeter of the wells define a detection region that is associated with or assigned to each well. For example, region 668 defined within the dashed lines at the perimeter of well 558-2 is assigned to well 558-2. In this context, the term “assigned” means that light being detected within region 668 is considered as emitted from well 558-2.

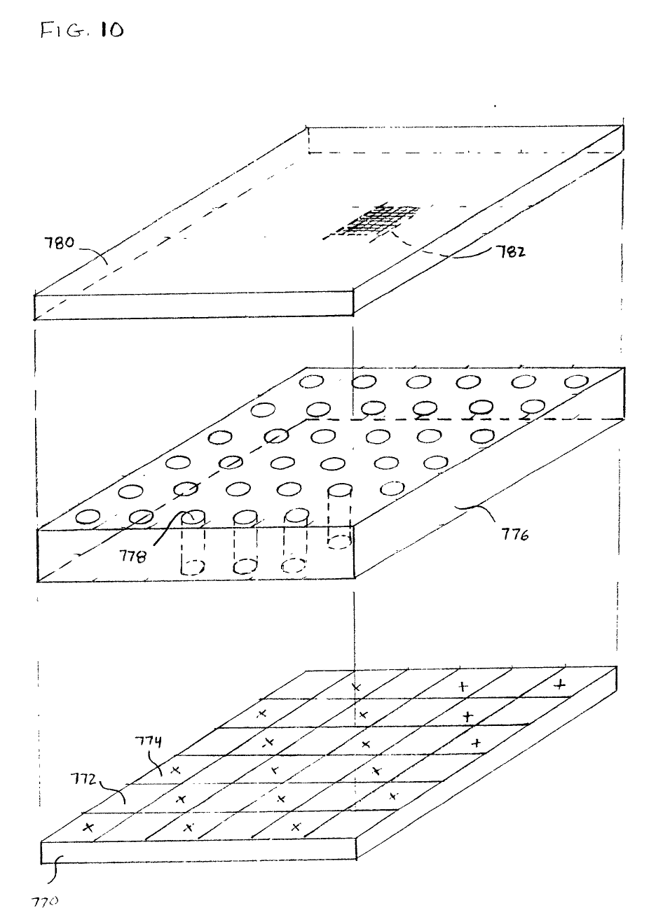

FIG. 8 shows that the light emitted from wells 558-2, 558-4 and 558-6 overlaps with increasing distance from the wells. In particular, at plane 662, no overlap is observed, and substantially all light emitted from each well is detected at the assigned detection region and nowhere else. That is, the detection regions assigned to wells 558-1, 558-3 and 558-5 do not detect any light. This is depicted in FIG. 9, which shows intensity as a function of detection region by way of plots for each of planes 662, 664 and 666. These plots are shown for pedagogical purposes; they are not meant to be an accurate representation of the intensity distribution corresponding to FIG. 8.

The plot of intensity for plane 662 shows that detection region D2 assigned to well 558-2, detection region D4 assigned to well 558-4 and detection region D6 assigned to well 558-6 all detect light. On the other hand, detection regions D1, D3 and D5 assigned to respective inactive wells 558-1, 558-3 and 558-5 do not detect light.

Referring again to FIG. 8, at plane 664, the light that is emitted from the emitting wells overlaps. Consistent therewith, the plot of intensity at plane 664 (FIG. 9) indicates that light was detected at each detection region. Although each detection region detects light, the intensity is shown to be greatest at detection regions D2, D4 and D6. The ability to resolve such differences as light overlaps increases with an increase in the number of sensor elements per area on the detector (and assigned to a given well) and, of course, with the sophistication/capabilities of the associated signal processing equipment (e.g., hardware and software).

With continuing reference to FIG. 8, at plane 666, the light emitted from the emitting wells now overlaps to a substantial degree. The intensity plot for plane 666 in FIG. 9 is almost a flat line, indicating that the ability to resolve differences in activity between the wells has been lost. This loss in resolution is due, again, to the divergence of emitted radiation with an increase in gap g. Another problem that accompanies an increase in gap g is a reduction in signal strength that occurs as a result of the dispersion of emitted radiation due to air molecules and particles that are present in the path of the radiation.

In addition to a dependence on the number of sensing elements per area of the detector, gₘₐₓ is also dependent upon the geometry of the specimen plate. In particular, factors such as the diameter of the well, the shape of the well, and the liquid level of the reagents in the well can each affect gₘₐₓ.

A first approach to an estimate of the maximum acceptable size of gₘₐₓ of gap g is that gₘₐₓ is equal to the diameter of wells 558. According to this approach, for a 96-well plate, gₘₐₓ is about 5 to 6 millimeters, for a 384-well plate, gₘₐₓ is about 3 to 4 millimeters and for a 1536-well plate, gₘₐₓ is about 1 to 2 millimeters. Recalling the discussion of gmin, above, it is seen that, in some cases, gₘₐₓ is substantially equal to gₘᵢₙ.

A more rigorous procedure and arrangement for determining the maximum acceptable size gₘₐₓ of the gap g is provided below in conjunction with FIGS. 10 and 11. The procedure involves emitting light in a discrete pattern (e.g., a checkerboard, etc.) and determining the maximum distance at which a detector can detect the pattern. For consistency with the illustrative embodiment of the present invention, gₘₐₓ is determined in the absence of lenses or other optics that would otherwise increase gₘₐₓ by virtue of focusing/collimating abilities. Therefore, when the term “immediate proximity” is used in this specification to describe a distance relationship between reagents and a detector, the use of the term is understood to preclude the presence, between the specimen plate and the detector, of lenses or other optics for focusing/collimating light.

FIG. 10 depicts, via an exploded view, calibrated fluorescent light source 770, well-simulating layer 776, and detector 780, arranged as shown. Other required equipment, such as processing electronics, are not depicted to keep the focus on elements that are germane to an understanding of the present invention. Calibrated fluorescent light source 770 provides, as the name implies, a source of fluorescent light. The source is calibrated such that it provides a known and consistent (e.g., three percent coefficient of variation) intensity across the surface thereof. Such calibrated light sources are commercially available from Precision Dynamics Corp. of San Fernando, Calif., among others.

A pattern is imposed on calibrated fluorescent light source 770 such as by placing a mask on it. Some regions of the mask are open (i.e., allow light to pass), while other regions are blocked (i.e., do not allow light to pass). The configuration of open and blocked regions defines the pattern. For example, in FIG. 10, blocked regions 774 (which are identified by an “x”) and open regions 772 are arranged in a checkerboard pattern. The pattern simulates active and inactive (i.e., control) wells in a multi-well plate.

As previously described, gₘₐₓ is dependent upon, among factors, the diameter of the well, the shape of the well, and the liquid level of the reagents in the well. Since different types of multi-well plates (e.g., 96-well vs. 384 well vs. 1536-well) have different-sized diameter wells (i.e., ˜5-6 mm vs. ˜3-4 mm vs. ˜1-2 mm, respectively), an assumption or determination should be made as to what type of multi-well plate will be used to account for these parameters. Also, the liquid level in the wells during imaging should be estimated such that the distance between the mouth of the well and the liquid level can be determined.

Based on this information, well-simulating layer 776 is provided. Well-simulating layer 776, which, in use, is disposed on calibrated fluorescent light source 770, includes a plurality of holes 778. Holes 778 have a diameter consistent with the wells in the multi-well plate that will be used during imaging. Well-simulating layer 776 is provided with a thickness that is equal to the distance between the mouth of the well and the liquid-level in the well, as previously determined. The combination of calibrated fluorescent light source 770 and well-simulating layer 776 therefore mimics a multi-well plate having both inactive and active wells, and a specific liquid level in the active wells.

Detector 780 having a plurality of sensing elements 782, is positioned above well-simulating layer 776. The detector being used for this calibration should be equivalent to the detector used in imaging system 200 (e.g., same type, same number of sensing elements per area, etc.). Groups of sensing elements 782 are assigned to each well for the purpose of data acquisition and analysis.

Referring to FIG. 11, which depicts a simplified cross-sectional view of the arrangement shown in FIG. 10, the distance between detector 780 and the surface of well-simulating layer 776 is varied. The maximum distance at which detector 780 can resolve the simulated pattern of active and inactive wells (e.g., the checkerboard pattern, etc.) is the maximum permissible size gₘₐₓ of the gap g between reagents on specimen plate 218 and detector 222. Maximum permissible size gₘₐₓ is typically less than about 10 millimeters.

Thus, the term “immediate proximity,” as used in this specification, has been defined with reference to gap g between the reagents and detector 222, that falls within a range between gₘᵢₙ and gₘₐₓ. Gap g between the reagents and detector 222 is typically in a range between about 1 to 5 millimeters. As limited by gₘᵢₙ and gₘₐₓ, the permissible separation between specimen plate 218 and detector 222 is typically about 1-2 millimeters.

It might turn out that for some arrangements, and under some conditions, gₘₐₓ is less than gₘᵢₙ. This means that arrangement under consideration is not workable, since there will be no ability to resolve differences in activity between wells. If such a result is obtained, the geometry of the arrangement must be changed (e.g., to one of the other arrangements described herein, etc.).

It is to be understood that the above-described embodiments are merely illustrative of the invention and that many variations may be devised by those skilled in the art without departing from the scope of the invention and from the principles disclosed herein. It is therefore intended that such variations be included within the scope of the following claims and their equivalents.

I claim:

1. An article for imaging visible-spectrum radiation emitted from reagents that are disposed in an array on a specimen plate, said article comprising a detector operable to detect said visible-spectrum radiation and further operable to output a signal indicative of the detected visible-spectrum electromagnetic radiation, wherein,
when said article is in use, said reagents are in an immediate proximity of said detector.

2. The article of claim 1 further comprising said specimen plate, said plate having a surface upon which said reagents are disposed.

3. The article of claim 2 wherein said reagents are within about 7 millimeters of said detector.

4. The article of claim 3 wherein said reagents are within about 5 millimeters of said detector.

5. The article of claim 2 wherein said specimen plate is less than about 2 millimeters from said detector.

6. The article of claim 5 wherein said specimen plate is less th an about 1 millimeter from said detector.

7. The article of claim 6 wherein said specimen plate abuts said detector.

8. The article of claim 2 wherein said surface comprises a plurality of wells.

9. The article of claim 2 wherein said specimen plate is disposed beneath said detector in a first position when said detector is detecting said visible-spectrum electromagnetic radiation.

10. The article of claim 9 further comprising a positioner operable to move said specimen plate between said first position and a second position in which said specimen plate is not beneath said detector.

11. The article of claim 2 further comprising:
an excitation radiation source that is disposed beneath said specimen plate; and
an excitation radiation filter that is disposed between said specimen plate and said detector, wherein said excitation radiation filter is operable to substantially prevent excitation radiation from reaching said detector.

12. The article of claim 2 wherein said specimen plate is disposed above said detector in a first position when said detector is detecting said visible-spectrum electromagnetic radiation.

13. The article of claim 12 wherein:
said specimen plate is inverted;
said surface comprises a plurality of wells; and
said wells have a diameter that is sufficiently small to cause a capillary effect whereby liquid contained in said wells is retained therein when said plate is inverted.

14. The article of claim 12 further comprising:
an excitation radiation source that is disposed above said specimen plate; and
an excitation radiation filter that is disposed between said specimen plate and said detector, wherein said excitation radiation filter is operable to substantially prevent excitation radiation from reaching said detector.

15. The article of claim 12 further comprising:
an excitation radiation source that is disposed above said plate but not centered thereover so that excitation radiation emitted from said excitation radiation source is received by said plate at a non-normal and shallow angle; and
a grating filter that is disposed between said plate and said detector, wherein said grating filter is operable to substantially prevent excitation radiation from reaching said detector.

16. The article of claim 1 wherein said detector comprises a polymer photodiode array.

17. The article of claim 1 further comprising:
software operable to analyze said signal;
memory for storing said software; and
a processor operable to run said software.

18. An article comprising:
a detector operable to detect visible-spectrum electromagnetic radiation and to output a signal indicative of the detected electromagnetic radiation; and
a space between said detector and a surface that receives reagents that are the source of said visible-spectrum electromagnetic radiation, said surface being present when said detector is detecting said electromagnetic radiation, wherein said space is less than about 2 millimeters.

19. The article of claim 18 further comprising:
an excitation radiation filter that is disposed between said surface and said detector, wherein said excitation radiation filter is operable to substantially prevent excitation radiation from reaching said detector.

20. The article of claim 19 further comprising an excitation radiation source for providing said excitation radiation.

21. The article of claim 20 wherein said excitation radiation source is disposed above said surface.

22. The article of claim 20 wherein said excitation radiation source is disposed below said surface.

23. The article of claim 18 wherein said detector comprises a polymer photodiode array.

24. The article of claim 23 wherein said detector has a plurality of holes defined therein.

25. An article comprising:
a detector operable to detect visible-spectrum electromagnetic radiation and to output a signal indicative of the detected electromagnetic radiation;
a gap between said detector and reagents that are disposed on a surface, wherein said reagents are a source of said visible-spectrum electromagnetic radiation, said surface being present when said detector is detecting said electromagnetic radiation;
an excitation radiation source for producing excitation radiation that is directed toward said reagents; and
an excitation radiation filter that is disposed between said surface and said detector, wherein said excitation radiation filter is operable to substantially prevent excitation radiation from reaching said detector;
wherein there are no optics present in said gap that collimate or focus said visible-spectrum electromagnetic radiation on said detector.

26. The article of claim 25 further comprising a specimen plate, said plate having said surface upon which said reagents are disposed.
